(19) United States
(12) Patent Application Publication
(10) Pub. No.: US 2026/0111551 A1
(43) Pub. Date: Apr. 23, 2026

(54) Method for Managing Firmware Versions for Functional Security Components, and Electric Device

(71) Applicant: Andreas KRAUSE

(72) Inventor: Andreas KRAUSE

(21) Appl. No.: 18/868,384

(22) PCT Filed: May 25, 2023
(86) PCT No.: PCT/EP2023/064006

§ 371 Date: Jan. 7, 2026

(51) Int. Cl. G06F 21/57; G06F 21/60

(52) U.S. Cl. CPC G06F 21/572; G06F 21/604

(57) ABSTRACT

A method for managing firmware versions for functional security components includes the steps of: transmitting a firmware packet to a functional security component, wherein the firmware packet has a signature and a firmware list which has a firmware list version number, and the firmware list includes permissible firmware version numbers; checking the author of the firmware packet by means of the functional security component using the signature; if the author is a permissible author, using the functional security component to check whether no firmware list is stored in a non-volatile storage region of the functional security component or if a firmware list which has an older firmware list version number than the firmware list version number of the transmitted firmware list is stored in the non-volatile storage region; and when no firmware list is stored or when a firmware list which has an older firmware list version number is stored, storing the transmitted firmware list or overwriting the firmware list having the older firmware list version number with the transmitted firmware list.

### BACKGROUND AND SUMMARY

The invention is based on the object of providing a method for managing firmware versions for functional security components as well as an electrical device, by means of which firmware can be easily and securely managed.

The method for managing firmware versions for (hardware-based and microprocessor-based) functional security components has the following steps.

Initially, a firmware packet is transmitted, for example from a service PC via a data network, to a functional security component, wherein the firmware packet has a signature, which has been generated by means of cryptographic methods, and a firmware list having a firmware list version number. The firmware list includes permissible firmware version numbers and firmware versions.

Thereafter, an author of the firmware packet is checked by means of the functional security component using the signature.

Only if the author is a permissible author, the functional security component is used to check whether no firmware list is stored in a non-volatile memory or a memory region of the non-volatile memory of the functional security component or if a firmware list which has an older firmware list version number than the firmware list version number of the transmitted firmware list is stored in a non-volatile memory or a memory region of the non-volatile memory of the functional security component. If no firmware list or a firmware list which has an older firmware list version number than the firmware list version number of the transmitted firmware list is stored, the transmitted firmware list is stored or the firmware list which has the older firmware list version number than the firmware list version number of the transmitted firmware list is overwritten with the transmitted firmware list.

According to one embodiment, after the functional security component is powered on, the functional security component is used to check whether a firmware is stored in a memory location of the functional security component intended therefor and, if a firmware is stored in the memory location of the functional security component intended therefor, the functional security component is used to check whether the firmware version number of the stored firmware is included in the stored firmware list as a permissible firmware version number. If the firmware version number of the stored firmware is included in the stored firmware list as a permissible firmware version number, the stored firmware is started and run by the functional security component. Otherwise, an error handling procedure is carried out without the stored firmware being started.

According to one embodiment, the firmware packet also includes a firmware which is intended to be stored in the/a memory location of the functional security component intended therefor.

According to one embodiment, the functional security components conform to or are compliant with the standard IEC 61508, in particular the standard IEC 61511 and/or the standard IEC 62061. The functional security components can conform to a safety integrity level between SIL1 to SIL4.

The electrical device has at least one functional security component, wherein the electrical device is designed to carry out an above-described method for managing firmware versions for the at least one functional security component.

Microcontroller-based components having firmware for security functions or functional security functions that are subject to the lifecycle model of IEC or EN 61508 and the associated sector standards have high requirements for ensuring the safety integrity. The focus is on the aspects of compatibility between the firmware and associated device hardware and ensuring that preferably only firmware which has been released by the manufacturer can be loaded onto the (hardware) components. Firmware updates of functional security components are therefore reserved for conventional specialists having specific knowledge and tools. The invention also enables firmware updates for non-specifically trained users.

The functional security component typically has a bootloader. The manufacturer of the functional security component provides firmware packets for download, which firmware packets include a functional device firmware for the electrical device as well as the firmware for the functional security component. The manufacturer ensures that the versions are compatible with one another. The firmware packets are loaded onto the electrical devices or the functional security components, for example, using tools provided therefor. The tools are preferably not specific service tools, but rather tools that are already used for other tasks.

The firmware packet has a signature that enables the bootloader of the functional security component to unambiguously identify the author.

The firmware packets include a firmware list of all released and blocked security-relevant firmware version numbers, which firmware list cannot be manipulated by a user.

The firmware list is stored by means of a firmware download in a memory that cannot be overwritten by the user.

The firmware list has a version control or a firmware list version number. If a firmware list is already stored in the independent, non-erasable memory region, it is automatically overwritten with the firmware update if the received firmware list version number is greater than or newer than the stored firmware list version number.

The functional security component or its installed firmware checks, using the firmware list upon start-up, whether the firmware has a firmware version number that has been released. This query is included in the firmware starting with the first firmware version number that is provided in the firmware packet.

The firmware list is updated for all firmware version numbers that are provided by the manufacturer. This means that older released versions are also included in the current firmware list.

If a firmware list that is newer than the firmware list that was just received is located on the device or the functional security component, it is not overwritten. It is therefore ensured that the security components always know the current released firmware version numbers.

If an update of the firmware has been carried out for a functional security component, the firmware can be released via deliberate action by the user. This can be carried out individually for each functional security component. A release tool that can be used is a certain software. By means of the release tool, a communication link to the functional security component can be established. The release tool generates a release command, which includes information such as serial number and axis information, which can be evaluated by the firmware of the functional security component. Once the check is successful, the firmware is released.

The invention will now be explained with reference to the accompanying drawing.

### BRIEF DESCRIPTION OF THE DRAWING

FIG. 1 is a highly schematic block diagram illustrating an electrical device including a functional security component, in which a firmware update of the functional security component is carried out.

### DETAILED DESCRIPTION OF THE DRAWING

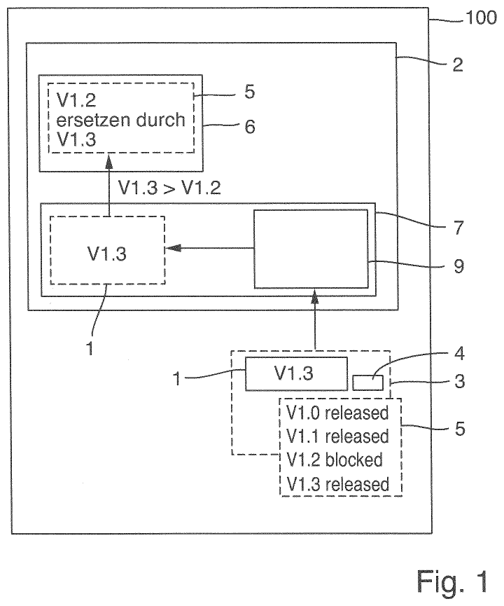

FIG. 1 shows an electrical device 100 in the form of a frequency converter having a functional security component 2, which provides functionalities according to the standard IEC 61508, IEC 61511, and/or IEC 62061. The functional security component 2 can conform, for example, to a safety integrity level between SIL1 to SIL4.

Of course, the electrical device 100 has even more function blocks (not shown) which interact as necessary with the functional security component 2 such that the corresponding functional security standard is met. In this regard, reference is made to the relevant technical literature.

The functional security component 2 has a FRAM (Ferroelectric Random Access Memory) 6 and a flash memory 7. The FRAM 6 is provided for storing a firmware list 5. The flash memory 7 is provided for storing a firmware 1 of the component 2. Instead of a FRAM, for example, a MRAM (Magnetoresistive Random Access Memory) can also be used.

An update of the firmware 1 including the firmware list 5 is described in the following.

The manufacturer of the functional security component 2 provides firmware packets 3 for download, which firmware packets include a functional device firmware (not shown) for the electrical device 100 as well as the firmware 1 for the functional security component 2. The firmware packets 3 are loaded onto the electrical device 1 or the functional security component 2, for example, using tools provided therefor.

The firmware packet 3 has a signature 4, which enables a bootloader 9 of the component 2 to unambiguously identify the author of the firmware packet 3 and to use only those firmware packets 3 that originate from an intended author.

The firmware packets 3 include the firmware list 5, which cannot be manipulated by a user and includes all permissible and non-permissible firmware version numbers. For example, the firmware list 5 includes firmware version numbers V1.0, V1.1, and V1.3, which have been designated as permissible and are labeled here as “released”, and a firmware version number V1.2, which has been designated as non-permissible and is labeled here as “blocked”.

The firmware list 5 has a firmware list version number V1.3. If a firmware list 5 is already stored in the independent, non-erasable memory region or the FRAM 6, it is automatically overwritten with the firmware update if the received firmware list version number is greater than or newer than the stored firmware list version number. In the present case, an older firmware list 5 having the firmware list version number V1.2 is overwritten with the firmware list 5 having the firmware list version number V1.3.

The functional security component 2 or its installed firmware 1 checks, using the firmware list 5 upon start-up, whether the firmware 1 has a firmware version number that has been released. This query is included in the firmware 1 starting with the first firmware version number that is provided in the firmware packet 3.

The firmware list 5 is updated for all firmware version numbers that are provided by the manufacturer. This means that older released firmware version numbers are also included in the current firmware list 5.

If a firmware list that is newer than the firmware list that was just received is located on the electrical device 100 or the functional security component 2, it is not overwritten. It is therefore ensured that the functional security components 2 always know the current released firmware version numbers.

If an update of the firmware 1 has been carried out for a functional security component 2, this firmware 1 can be released via deliberate action by the user. This can be carried out individually for each functional security component 2.

A release tool that can be used is, for example, a certain service software. Using this software, a communication link to the functional security component 2 can be established. The release tool or its software generates a release command, which includes information such as serial number and axis information, which can be evaluated by the firmware 1 of the functional security component 2. Once the check is successful, the firmware 1 is released.

1.-6. (canceled)

7. A method for managing versions of firmware for functional safety components, the method comprising the steps of:
transmitting a firmware packet to a functional security component, wherein the firmware packet has a signature and a firmware list having a firmware list version number, wherein the firmware list includes permissible firmware version numbers;
checking an author of the firmware packet by way of the functional security component using the signature; and
when, based on the checking, the author is a permissible author, using the functional security component to check whether no firmware list is stored in a non-volatile memory region of the functional security component or whether a firmware list which has an older firmware list version number than the firmware list version number of the transmitted firmware list is stored in a non-volatile memory region of the functional security component, storing the transmitted firmware list or overwriting the firmware list having the older firmware list version number with the transmitted firmware list.

8. The method according to claim 7, wherein
after the functional security component is powered on, the functional security component is used to check whether a firmware is stored in a memory location of the functional security component intended therefor and,
when a firmware is stored in the memory location of the functional security component intended therefor, the functional security component is used to check whether the firmware version number of the stored firmware is included in the stored firmware list as a permissible firmware version number and, when the firmware version number is included in the stored firmware list, using the functional security component to start the stored firmware.

9. The method according to claim 8, wherein
the firmware packet also includes a firmware which is intended to be stored in a memory location of the functional security component intended therefor.

10. The method according to claim 7, wherein
the firmware packet also includes a firmware which is intended to be stored in a memory location of the functional security component intended therefor.

11. The method according to claim 7, wherein
the functional security components conform to standard IEC 61508.

12. The method according to claim 7, wherein
the functional security components conform to standard IEC 61511 and/or standard IEC 62061.

13. The method according to claim 11, wherein
the functional security components conform to a safety integrity level between SIL1 to SIL4.

14. An electrical device, comprising:
at least one functional security component;
wherein the electrical device is configured to manage firmware versions for the at least one functional security component by:
transmitting a firmware packet to a functional security component, wherein the firmware packet has a signature and a firmware list having a firmware list version number, wherein the firmware list includes permissible firmware version numbers;
checking an author of the firmware packet by way of the functional security component using the signature; and
when, based on the checking, the author is a permissible author, using the functional security component to check whether no firmware list is stored in a non-volatile memory region of the functional security component or whether a firmware list which has an older firmware list version number than the firmware list version number of the transmitted firmware list is stored in a non-volatile memory region of the functional security component, storing the transmitted firmware list or overwriting the firmware list having the older firmware list version number with the transmitted firmware list.
